(19) United States
(12) Patent Application Publication
(10) Pub. No.: US 2021/0016887 A1
(43) Pub. Date: Jan. 21, 2021

(54) BRACKET AND ARRANGEMENT OF A BRACKET

(71) Applicant: Rolls-Royce Deutschland Ltd & Co KG, Blankenfelde-Mahlow (DE)

(72) Inventors: Enrico STELLDINGER, Luebben (DE); Kai Navtej SINGH, Berlin (DE)

(21) Appl. No.: 16/511,226

(22) Filed: Jul. 15, 2019

(51) Int. Cl. B64D 27/00

(52) U.S. Cl. CPC B64D 27/00

(57) ABSTRACT

A bracket comprising a first planar portion having at least one bolt hole, a second planar portion angularly spaced apart from the first planar portion. The bracket may include an intermediate portion integral with the first planar portion and the second planar portion. The second planar portion includes projections and bolt holes, the projections are operable to interlock with cut-outs of flanges.

### TECHNICAL FIELD

The present disclosure relates generally to supporting arrangements, and more specifically, to a bracket for supporting flanges. The bracket is further supported by the flanges.

### BACKGROUND

An aircraft engine, i.e. a gas turbine engine, comprises a number of sections that are assembled in series and axially. Some components in such sections are mechanically engaged and fastened together by utilizing various types of fasteners. In an example, fasteners, such as, bolts or rivets may be used for coupling flanges, associated with casings, shafts, pipes and the like. Additionally, supporting arrangements may be employed to enhance a load bearing capacity of the flanges coupled with the fasteners.

Typically, an aircraft engine includes various supporting arrangements for improving load bearing capacity of components (such as flanges) supported with such supporting arrangements. One such implementation of a supporting arrangement includes use of brackets for providing additional support or supporting the brackets by flanges, which may be associated with the casings. Generally, such flanges include cut-outs (having shape of scallops or castellations). Mostly, the flanges are coupled to the brackets using bolts. The coupling of the brackets and the flanges using bolts may be efficient in bearing axial and radial loads, however, tangential or torsional load (i.e. torque) bearing capacity of such arrangement (i.e. flanges coupled to the brackets using bolts) may not be sufficient.

Therefore, in light of the foregoing discussion, there exists a need to overcome the aforementioned drawbacks associated with conventional flange supporting arrangement.

### SUMMARY

The present disclosure seeks to provide a bracket for supporting flanges or a bracket supported by flanges. The present disclosure seeks to provide a solution to the existing problem of efficient bearing of torsional load. An aim of the present disclosure is to provide a solution that overcomes at least partially the problems encountered in prior art, and provide a bracket to enhance torsional load bearing capacity of brackets and flanges.

Embodiments of the present disclosure provide a bracket comprising

a first planar portion having at least one bolt hole;

a second planar portion angularly spaced apart from the first planar portion, the second planar portion comprises projections and bolt holes, wherein the projections are operable to interlock with cut-outs of flanges.

The first planar portion and the second planar portion may be adjacent to each other or may be connected to each other by an intermediate portion integral with the first planar portion and the second planar portion.

Embodiments of the present disclosure substantially eliminate or at least partially address the aforementioned problems in the prior art, and provides interlocking of the bracket with flanges for improving torsional load bearing capacity of the flanges and the bracket.

Further, the present disclosure is directed to an arrangement comprising a bracket, at least one flange comprising cut-outs, and a bracket support. The bracket comprises a first planar portion having at least one bolt hole and a second planar portion angularly spaced apart from the first planar portion, the second planar portion comprises projections and bolt holes, wherein the projections interlock with the cut-outs of the at least one flange, and wherein the first planar portion is connected to the bracket support and the second planar portion is connected to the flange through the bolt holes, respectively.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a side-perspective view of a bracket, in accordance with an embodiment of the present disclosure; and

FIG. 2 is a perspective view of the bracket of FIG. 1 employed for supporting flanges, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

Embodiments of the present disclosure provide a bracket comprising

a first planar portion having at least one bolt hole;

a second planar portion angularly spaced apart from the first planar portion, the second planar portion comprises projections and bolt holes, wherein the projections are operable to interlock with cut-outs of flanges.

Embodiments of the present disclosure provide a bracket for supporting flanges or further supported by flanges. Typically, the bracket of the present disclosure is employed in conjunction with flanges having cut-outs (scallop or castellation shaped). The bracket is coupled to abutting flanges with the help of bolts passing through aligned bolt holes of the bracket and the abutting flanges. Further, the projections of the bracket are received by aligned cut-outs of the abutting flanges. This interlocks the bracket with the abutting flanges, which in turn locks tangential or rotary movement between the bracket and the flanges, and thereby substantially enhancing torsional load bearing capacity of the flanges and the bracket. The bracket of the present disclosure is easy to employ and install, without any need of change in structural configuration of the flanges.

The bracket comprises the first planar portion having at least one bolt hole. In an embodiment, the first planar portion is a substantially rectangular and planar structure having uniform thickness. Alternatively, the first planar portion may be configured to have any polygonal shape, such as triangular, square, trapezoidal or any combination thereof. Further, the first planar portion may have non-uniform thickness. The at least one bolt hole is operable to receive a bolt there-through for coupling the first planar portion to a bracket support. In an embodiment, the first planar portion may include multiple bolt holes, having either uniform or non-uniform diameter, operable to receive conforming bolts there-through for enabling coupling of the first planar portion with the bracket support.

The second planar portion may be oriented angularly to the first planar portion. For example, the first planar portion and the second planar portion encompass an angle, for example 45 degrees or 90 degrees or 135 degrees or any range therebetween. It will be appreciated that the first planar portion of the bracket is coupled to the bracket support, and the second planar portion is coupled to the flanges. The first planar portion and the second planar portion are integral, for example the first planar portion is directly connected to and adjacent the second planar portion.

I an embodiment, the second planar portion is angularly spaced apart from the first planar portion. It will be appreciated that the first planar portion of the bracket is coupled to the bracket support, and the second planar portion is coupled to the flanges. Further, the bracket support and the flanges are angularly oriented and spaced apart. Therefore, the second planar portion is configured to be angularly spaced apart from the first planar portion. In an embodiment, a plane of the first planar portion is substantially orthogonal to a plane of the second planar portion. In other words, the first planar portion and the second planar portion are perpendicular and spaced apart from each other. To this end an intermediate portion integral with the first planar portion and the second planar portion connects the first planar portion with the second planar portion.

In an embodiment, the second planar portion is a substantially rectangular structure having non-uniform thickness. Further, at least one longitudinal edge of the second planar portion is configured to be curved to conform to a peripheral edge of the flanges. Alternatively, the longitudinal edges of the second planar portion may be linear.

The second planar portion comprises bolt holes. It will be appreciated that based on a length of the second planar portion and diameter of the bolt holes, the second planar portion may include a specific number of bolt holes. In an example, the second planar portion includes three bolt holes. Alternatively, the second planar portion may include one or more bolt holes.

The second planar portion comprises projections. The projections are raised portions extending from a peripheral surface of a longitudinal edge of the second planar portion, and away from the first planar portion. The projections are configured to be received by cut-outs of the flanges. It will be appreciated that for the projections to be received by the cut-outs, there should be a clearance between the projections and the cut-outs, i.e. the projections have to be smaller in size as compared to the size of the cut-outs. In an example, the cut-outs are configured to have a shape of a scallop or a castellation. Accordingly, the projections are configured to have a shape conforming to the shape of the cut-outs (i.e. scallops or castellations). However, in the present embodiment, the projections are configured to have one of a cubical or cuboidal shape. Further, according to an embodiment, the projections are shaped to partially or completely conform to the shape of the cut-outs of the flanges. Essentially, the projections are shaped such that the projections are accommodated within a width of the cut-outs. However, the projections may or may not extend along an entire length of the cut-outs. Additionally, the projections may include thickness conforming to a thickness of the cut-outs of the flanges.

The intermediate portion is integral with the first planar portion and the second planar portion. In an embodiment, the intermediate planar portion is a substantially rectangular and planar structure having uniform thickness. Alternatively, the intermediate portion may be configured to have any polygonal shape, such as triangular, square, trapezoidal or any combination thereof. Optionally, the intermediate portion may include non-uniform thickness. In an embodiment, the intermediate portion includes a raised portion (for example, having a triangular shape) along a portion of a length of a longitudinal peripheral edge of the intermediate portion.

In an embodiment, a plane of the intermediate portion is substantially diagonal to the plane of the first planar portion and to the plane of the second planar portion. In other words, both the first and second planar portions are inclined to the intermediate portion, which allows the intermediate portion to be diagonally arranged to the first and second planar portions. In an example, the first planar portion may be inclined to the intermediate portion at an angle in a range of 120 degrees to 150 degrees. Similarly, the second planar portion may be inclined to the intermediate portion at an angle in the range of 120 degrees to 150 degrees. In an embodiment, both the first and second planar portions are inclined to the intermediate portion at 135 degrees. The different ranges of angles allow for compensating height differences between the bracket support and the flange.

The projections of the second planar portion are operable to interlock with cut-outs of flanges. In an exemplary implementation, the bolt holes of the second planar portion are operable to receive bolts there-through for coupling the second planar portion with the flanges. In an embodiment, the flanges are associated with casings, employed for covering various sections of a gas turbine engine. Further, the flanges include cut-outs, having shape of scallops or castellations, along peripheral edges thereof. In other words, peripheral edges of the flanges include crest and trough configuration formed by the cut-outs on the peripheral edges. In operation, the flanges are allowed to abut such that the cut-outs thereof align. It will be appreciated that each of the abutting flanges includes a plurality of bolt holes, and when the cut-outs are aligned, the plurality of bolt holes also align. Thereafter, the second planar portion is arranged on the abutting flanges, such that the bolt holes of the second planar portion aligns with the plurality of bolt holes of the abutting flanges. In the process, the projections of the second planar portion are received by the cut-outs of the abutting flanges. This interlocks the bracket (particularly, the second planar portion) with the abutting flanges. The bolt holes are operable to receive the bolts there-through. Thereafter, nuts are threadably coupled to the bolts for coupling the second planar portion with the abutting flanges.

According to an embodiment, the bracket is a monolithic piece of material formed by moulding, casting or machining. The term “monolithic piece of material” is to be construed as an integral structure, i.e. the first and second planar portions of the bracket are integral with the intermediate portion. Further, the bracket may be formed using material, such as metal, plastic, rubber or any combination. In an example, the bracket may be made of iron or steel. Moreover, the bracket may be made using said material by using one of a well know technique, such as moulding, casting or machining.

In an embodiment, the bracket of the present disclosure is adapted to be used in an aircraft engine. The bracket of the present disclosure may be employed as a supporting arrangement or may be being further supported by the flanges. The term “supporting arrangement” refers to an arrangement that is employed additionally (i.e. in addition to a primary coupling arrangement generally provided by fasteners) to further enhance a load bearing capacity of components (such as the flanges or the brackets vice versa) that are coupled using the primary coupling arrangement. In other words, the supporting arrangement provides additional support for bearing load to the primary coupling arrangement. In an example, the bracket of the present disclosure may be employed as a flange supporting arrangement. Additionally, or alternatively, the flanges may act as further bracket support. Typically, the bracket is used in conjunction with the flanges of casings having the cut-outs. However, it will be appreciated that the bracket may be used in conjunction with any other flanges having cut-outs, such as flanges associated with coupling of the shafts or pipes. This way, the brackets may be used to support the casing, to stiffen the casing or to carry a payload such as an accessory part. By utilising an interlocking feature in addition to the bolted joint the load transfer capability is increased.

### DETAILED DESCRIPTION OF THE DRAWINGS

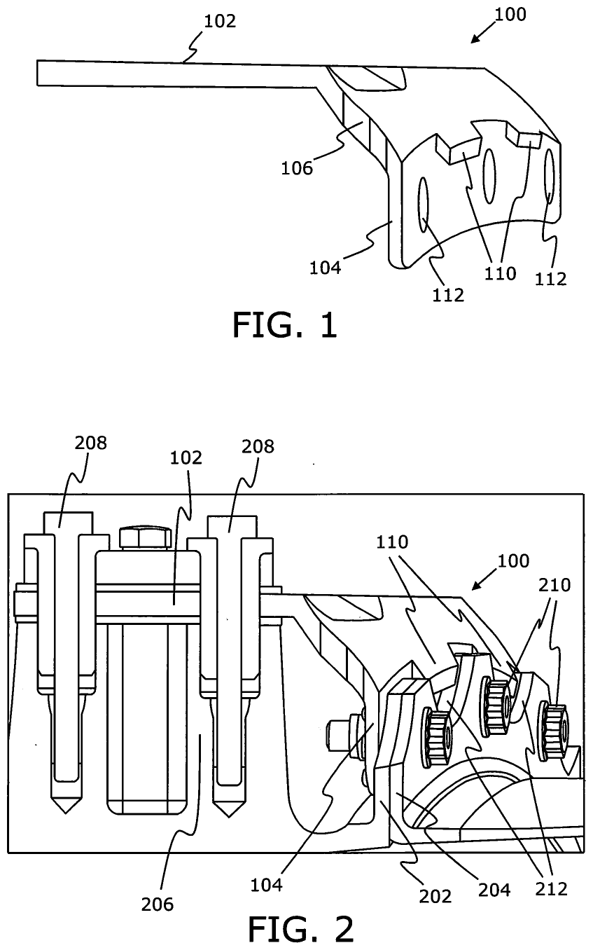

Referring to FIG. 1, illustrated is a side-perspective view of a bracket 100, in accordance with an embodiment of the present disclosure. The bracket 100 includes a first planar portion 102 having at least one bolt hole (not shown). The bracket 100 also includes a second planar portion 104 angularly spaced apart from the first planar portion 102. The bracket 100 also includes an intermediate portion 106 integral with the first planar portion 102 and the second planar portion 104. The second planar portion 104 includes projections 110 and bolt holes 112. The projections 110 are operable to interlock with cut-outs of flanges (shown in FIG. 2).

Referring to FIG. 2, illustrated is a perspective view of an arrangement of the bracket 100 of FIG. 1 employed for supporting flanges 202, 204, in accordance with an embodiment of the present disclosure. As shown, the first planar portion 102 is coupled to a bracket support 206 using bolts 208. Further, the second planar portion 104 is shown coupled to the abutting flanges 202, 204 using bolts 210. The projections 110 are shown to be received by cut-outs 212, thereby interlocking the projections 110 with the flanges 202, 204.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A bracket comprising:
a first planar portion including a first bolt hole;
a second planar portion angularly spaced apart from the first planar portion, wherein the second planar portion includes a second bolt hole; and
an intermediate planar portion including a first end edge connecting to the first planar portion and a second end edge connecting to the second planar portion, wherein the intermediate planar portion includes a plurality of spaced apart projections extending from the second end edge over the second planar portion, and wherein the projections are operable to interlock with cut-outs between flanges positioned at the second planar portion.

2. (canceled)

3. The bracket according to claim 1, wherein a plane of the intermediate planar portion is substantially diagonal to a plane of the first planar portion and to a plane of the second planar portion, and the plane of the first planar portion is substantially orthogonal to the plane of the second planar portion.

4. The bracket according to claim 1, wherein the projections are shaped to partially or completely conform to a shape of the cut-outs between the flanges.

5. The bracket according to claim 1, wherein the bracket is a monolithic piece of material formed by one chosen from moulding, machining, and casting.

6. The bracket according claim 1 for use in an aircraft engine.

7. An arrangement, comprising:
a bracket further comprising:
a first planar portion including a first bolt hole;
a second planar portion angularly spaced apart from the first planar portion, wherein the second planar portion includes a second bolt hole; and
an intermediate planar portion including a first end edge connecting to the first planar portion and a second end edge connecting to the second planar portion, wherein the intermediate planar portion includes a plurality of spaced apart projections extending from the second end edge over the second planar portion;
a plurality of flanges, wherein the projections interlock with cut-outs between the plurality of flanges; and
a bracket support, and wherein the first planar portion is connected to the bracket support and the second planar portion is connected to the plurality of flanges.

8. An aircraft engine comprising a bracket according to claim 1.

9. (canceled)
